(19) United States
(12) Patent Application Publication
(10) Pub. No.: US 2024/0324045 A1
(43) Pub. Date: Sep. 26, 2024

(54) APPARATUS AND OPERATING METHOD OF NETWORK CONTROLLED REPEATER RELEATED TO BEAM FAILURE DETECTION IN NEXT-GENERATION MOBILE COMMUNICATION

(71) Applicant: Samsung Electronics Co., Ltd., Gyeonggi-do (KR)

(72) Inventor: June HWANG, Gyeonggi-do (KR)

(21) Appl. No.: 18/613,369

(22) Filed: Mar. 22, 2024

(30) Foreign Application Priority Data
Mar. 23, 2023 (KR) 10-2023-0038263

(51) Int. Cl. H04W 76/19; H04W 74/00; H04W 74/0833; H04W 80/02

(52) U.S. Cl. CPC H04W 76/19; H04W 74/002; H04W 74/0833; H04W 80/02

(57) ABSTRACT

The disclosure relates to a 5G or 6G communication system for supporting a higher data transmission rate. A method performed by an NCR MT in a wireless communication system is provided. The method includes receiving side control information including a forwarding configuration, in case that a beam failure occurs, transmitting, to an NCR forwarding, a first indication to cease forwarding, initiating a beam failure recovery procedure for the NCR MT, and in case that the beam failure recovery procedure is successfully completed, transmitting, to the NCR forwarding, a second indication to resume forwarding by using the forwarding configuration.

### CROSS-REFERENCE TO RELATED APPLICATION

This application is based on and claims priority under 35 U.S.C. § 119 to Korean Patent Application No. 10-2023-0038263, which was filed in the Korean Intellectual Property Office on Mar. 23, 2023, the disclosure of which is incorporated by reference herein in its entirety.

### BACKGROUND

### 1. Field

The disclosure relates generally to an operation of a user equipment (UE) in a mobile communication system, and more particularly, to a wireless repeater controlled by a base station (BS).

### 2. Description of the Related Art

5^{th} generation (5G) mobile communication technologies define a wide frequency band for faster data rates and new services, and can be implemented in a frequency band of a ‘sub 6 gigahertz (GHz)’ band, e.g., 3.5 GHZ, as well as in an ultra-high frequency band (i.e., a millimeter wave (mmWave)) of an ‘above 6 GHz’ band, such as 28 GHZ, 39 GHZ, etc.

In 6^{th} generation (6G) mobile communication technologies, which may be referred to as a beyond-5G system, in order to achieve a data rate that is 50 times as fast as 5G mobile communication technologies and 1/10 an ultra-low latency thereof, it has been considered to implement 6G mobile communication technologies in a terahertz (THz) band (e.g., 95 GHz to 3 THz bands).

Since the initial development of 5G mobile communication technologies, in order to support services and satisfy performance requirements in association with enhanced mobile broadband (eMBB), ultra reliable low latency communications (URLLC), and massive machine-type communications (mMTC), there has been ongoing standardization regarding beamforming and massive multiple input, multiple output (MIMO) for decreasing path loss of radio waves and increasing transmission distances of radio waves in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

There are also ongoing discussions about improvement and performance enhancement of initial 5G mobile communication technologies in view of services to be supported by newer 5G mobile communication technologies, e.g., physical layer standardization with respect to technologies such as vehicle-to-everything (V2X) for aiding driving determination by autonomous vehicles based on information about positions and states of vehicles transmitted by the vehicles and for enhancing user convenience, New Radio Unlicensed (NR-U) aimed at system operations conforming to various regulation-associated requirements in unlicensed bands, NR UE power saving, a non-terrestrial network (NTN), which is UE-satellite direct communication for providing coverage in an area in which communication with terrestrial networks is unavailable, and positioning.

There is also ongoing standardization in air interface architecture/protocols regarding technologies such as industrial Internet of things (IIoT) for supporting new services via interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR).

There is also ongoing standardization in system architecture/services regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, the number of devices that will be connected to communication networks is expected to exponentially increase, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, drone communication, etc.

Development of 5G mobile communication systems will also serve as a basis for developing new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIS), as well as full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

Because various services can be provided due to the aforementioned development of mobile communication systems, there is demand for a method of effectively providing the services.

### SUMMARY

Accordingly, an aspect of the disclosure is to provide, for a network controlled repeater (NCR), methods suspending operation of a forwarding entity upon occurrence of beam failure (BF) and to be performed after recovery from the BF.

In accordance with an aspect of the disclosure, a method performed by an NCR mobile termination (MT) in a wireless communication system is provided. The method includes receiving side control information including a forwarding configuration; in case that a beam failure occurs, transmitting, to an NCR forwarding, a first indication to cease forwarding; initiating a beam failure recovery procedure for the NCR MT; and in case that the beam failure recovery procedure is successfully completed, transmitting, to the NCR forwarding, a second indication to resume forwarding by using the forwarding configuration.

In accordance with an aspect of the disclosure, an NCR MT is provided, which includes a transceiver and at least one processor. The at least one processor is configured to receive side control information including a forwarding configuration, in case that a beam failure occurs, transmit, to an NCR forwarding, a first indication to cease forwarding, initiate a beam failure recovery procedure for the NCR MT, and in case that the beam failure recovery procedure is successfully completed, transmit, to the NCR forwarding, a second indication to resume forwarding by using the forwarding configuration.

In accordance with an aspect of the disclosure, a method performed by an NCR forwarding in a wireless communication system is provided. The method includes, in case that a beam failure occurs, receiving, from an NCR MT, a first indication to cease forwarding; and in case that a beam failure recovery procedure is successfully completed, receiving, from the NCR MT, a second indication to resume forwarding by using a forwarding configuration. The forwarding configuration is received before the beam failure.

In accordance with an aspect of the disclosure, an NCR forwarding is provided, which includes a transceiver and at least one processor. The at least one processor is configured to, in case that a beam failure occurs, receive, from an NCR MT, a first indication to cease forwarding, and in case that a beam failure recovery procedure is successfully completed, receive, from the NCR MT, a second indication to resume forwarding by using a forwarding configuration. The forwarding configuration is received before the beam failure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a long term evolution (LTE) system according to an embodiment;

FIG. 2 illustrates a radio protocol architecture of an LTE system according to an embodiment;

FIG. 3 illustrates a next-generation mobile communication system according to an embodiment;

FIG. 4 illustrates a radio protocol architecture of a next-generation mobile communication system according to an embodiment;

FIG. 5 illustrates a UE according to an embodiment;

FIG. 6 illustrates an NR BS according to an embodiment;

FIG. 7 illustrates an NCR according to an embodiment;

FIG. 8 illustrates a procedure for performing a BF recovery, according to an embodiment;

FIG. 9 is a signal flow diagram illustrating a method of resuming forwarding (FWD) ON, according to an embodiment; and

FIG. 10 is a signal flow diagram illustrating a method of resuming FWD ON based on information from a network, according to an embodiment.

### DETAILED DESCRIPTION

Hereinafter, operational principles of the disclosure will be described in detail with reference to accompanying drawings.

In the following descriptions of the disclosure, well-known functions or configurations are not described in detail when it is deemed that they may unnecessarily obscure the essence of the disclosure. The terms used in the specification are defined in consideration of functions used in the disclosure, and can be changed according to the intent or commonly used methods of users or operators. Accordingly, definitions of the terms are understood based on the entire description of the present specification.

Herein, terms identifying an access node, terms indicating network entities, terms indicating messages, terms indicating an interface between network entities, and terms indicating various pieces of identification information, as used in the following descriptions, are exemplified for convenience of descriptions. Accordingly, the disclosure is not limited to the terminology used below, and other terms indicating objects having equal technical meanings may be used.

Throughout the disclosure, the expression “at least one of a, b or c” indicates only a, only b, only c, both a and b, both a and c, both b and c, all of a, b, and c, or variations thereof.

Throughout the specification, a layer may also be referred to as an entity.

Herein, a BS is an entity that allocates resources to a terminal, and may be at least one of a next-generation node B (gNB), an evolved node B (eNB), a Node B, a radio access unit, a BS controller, or a node on a network.

A terminal may include a UE, a mobile station (MS), a cellular phone, a smartphone, a computer, or a multimedia system capable of performing a communication function.

Herein, a downlink (DL) is a wireless transmission path of a signal transmitted from a BS to a UE, and an uplink (UL) is a wireless transmission path of a signal transmitted from a UE to a BS.

Although the following descriptions may be provided with reference to LTE or LTE-Advanced (LTE-A) systems as an example, embodiments of the disclosure are also applicable to other communication systems having similar technical backgrounds or channel structure. For example, embodiments of the disclosure may be applicable to a system including 5G NR communication technology developed after an LTE-A system, and 5G may indicate a concept including LTE, LTE-A, and other similar services according to the related art. The disclosure is also applicable to other communication systems through modification at the discretion of one of ordinary skill in the art without greatly departing from the scope of the disclosure.

Each block of flowchart illustrations, and combinations of blocks in the flowchart illustrations, may be implemented by computer program instructions.

The computer program instructions may be provided to a processor of a general-purpose computer, special purpose computer, or other programmable data processing apparatus, such that the instructions, which are executed via the processor of the computer or other programmable data processing apparatus, generate means for performing functions specified in the flowchart block(s). The computer program instructions may also be stored in a computer-executable or computer-readable memory that may direct the computer or other programmable data processing apparatus to function in a particular manner, such that the instructions stored in the computer-executable or computer-readable memory may produce an article of manufacture including instruction means that perform the functions specified in the flowchart block(s). The computer program instructions may also be loaded onto the computer or other programmable data processing apparatus to cause a series of operational steps to be performed on the computer or other programmable apparatus to produce a computer implemented process such that the instructions that are executed on the computer or other programmable apparatus provide operations for implementing the functions specified in the flowchart block(s).

In addition, each block of the flowchart illustrations may represent a module, segment, or portion of code, which includes one or more executable instructions for performing specified logical function(s).

In some alternative implementations, the functions noted in the blocks may occur out of the order. For example, two blocks shown in succession may in fact be executed substantially concurrently or the blocks may sometimes be executed in the reverse order, depending upon the functionality involved.

The term “ . . . unit” as used herein may refer to a software or hardware component, such as field-programmable gate array (FPGA) or application-specific integrated circuit (ASIC), which performs certain tasks. However, the term “ . . . unit” is not limited to software or hardware. For example, a “ . . . unit” may be configured to be in an addressable storage medium or configured to operate one or more processors. Thus, a “ . . . unit” may include, by way of example, components, such as software components, object-oriented software components, class components, and task components, processes, functions, attributes, procedures, subroutines, segments of program code, drivers, firmware, microcode, circuitry, data, databases, data structures, tables, arrays, and variables. The functionality provided in the elements and “ . . . units” may be combined into fewer elements and “ . . . units” or further separated into additional elements and “ . . . units”. Further, the elements and “ . . . units” may be implemented to operate one or more central processing units (CPUs) in a device or a secure multimedia card. Also, a “ . . . unit” may include one or more processors.

For convenience of descriptions, the disclosure uses terms and names defined in 5G system (5GS) and NR rules, which are the standards defined by the 3rd Generation Partnership Project (3GPP). However, the disclosure is not limited to these terms and names, and may be equally applied to communication systems conforming to other standards.

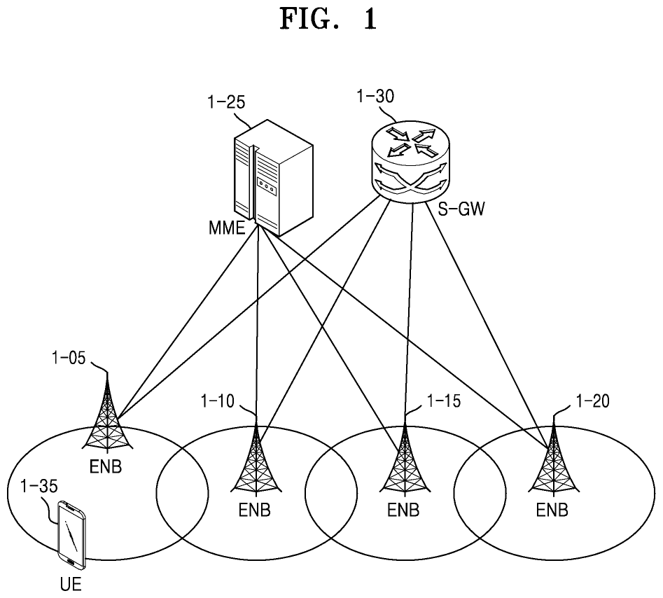

FIG. 1 illustrates an LTE system according to an embodiment.

Referring to FIG. 1, a radio access network of the LTE system includes a plurality of next-generation BSs (e.g., eNBs, nodes B, or BSs) 1-05, 1-10, 1-15, and 1-20, a mobility management entity (MME) 1-25, and a serving-gateway (S-GW) 1-30. A UE (or a terminal) 1-35 may access an external network via the eNB 1-05, 1-10, 1-15, or 1-20 and the S-GW 1-30

The eNB 1-05, 1-10, 1-15, or 1-20 may correspond to a legacy node B of a universal mobile telecommunications system (UMTS). The eNB 1-05, 1-10, 1-15, or 1-20 may be connected to the UE 1-35 via wireless channels and may perform complex functions, compared to the legacy node B.

In the LTE system, all user traffic data including real-time services such as voice over Internet protocol (VOIP) may be serviced via shared channels. Therefore, an entity for performing scheduling by collating status information of UEs, the state information including buffer state information, available transmit power state information, and channel state information, may be required and the eNB 1-05, 1-10, 1-15, or 1-20 may operate as such an entity.

An eNB may generally control a plurality of cells. For example, the LTE system may use a radio access technology such as orthogonal frequency division multiplexing (OFDM) at a bandwidth of 20 MHz to achieve a data rate of 100 Mbps. Also, the LTE system may use adaptive modulation & coding (AMC) to determine a modulation scheme and a channel coding rate in accordance with a channel state of the UE 1-35.

The S-GW 1-30 is an entity for providing data bearers and may establish or release the data bearers according to the control by the MME 1-25. The MME 1-25 is an entity for performing a mobility management function and various control functions on the UE 1a-35 and may be connected to the plurality of eNBs 1-05, 1-10, 1-15, and 1-20.

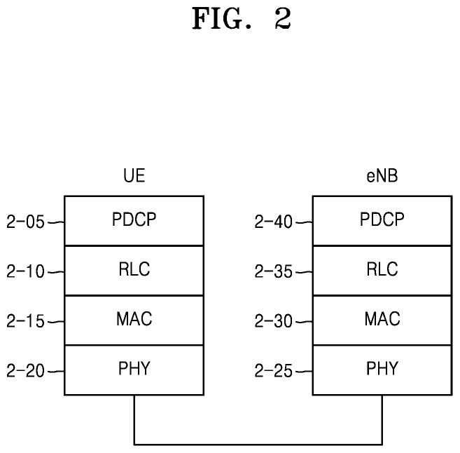

FIG. 2 illustrates a radio protocol architecture of an LTE system according to an embodiment.

Referring to FIG. 2, the radio protocol architecture of the LTE system includes packet data convergence protocol (PDCP) layers 2-05 and 2-40, radio link control (RLC) layers 2-10 and 2-35, medium access control (MAC) layers 2-15 and 2-30, and physical (PHY) layers 1b-20 and 1b-25, respectively, for a UE and a LTE eNB.

The PDCP layer 2-05 or 2b-40 is in charge of, e.g., Internet protocol (IP) header compression/decompression. More specifically, functions of the PDCP layer 2-05 or 2b-40 may be summarized as shown below:
Header compression and decompression: robust header compression (ROHC) only
Transfer of user data
In-sequence delivery of upper layer packet data units (PDUs) at PDCP re-establishment procedure for RLC acknowledged mode (AM)
For split bearers in dual connectivity (DC) (only support for RLC AM): PDCP PDU routing for transmission and PDCP PDU reordering for reception
Duplicate detection of lower layer service data units (SDUs) at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in UL

The RLC layer 2-10 or 2-35 performs, e.g., an automatic repeat request (ARQ) operation by reconfiguring PDCP PDUs to appropriate sizes. More specifically, functions of the RLC layer 2-10 or 2-35 may be summarized as shown below:
Transfer of upper layer PDUs
Error correction through ARQ (only for AM data transfer)
Concatenation, segmentation and reassembly of RLC SDUs (only for unacknowledged mode (UM) and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

The MAC layer 2-15 or 2-30 may be connected to a plurality of RLC layers configured for one UE, and may multiplex RLC PDUs into a MAC PDU and demultiplex the RLC PDUs from the MAC PDU. More specifically, functions of the MAC layer 2-15 or 2-30 may be summarized as shown below:
Mapping between logical channels and transport channels
Multiplexing/demultiplexing of MAC SDUs belonging to one or different logical channels into/from transport blocks (TBs) delivered to/from the physical layer on transport channels
Scheduling information reporting
Error correction through hybrid ARQ (HARQ)
Priority handling between logical channels of one UE
Priority handling between UEs by means of dynamic scheduling
Multimedia broadcast/multicast service (MBMS) identification
Transport format selection
Padding

The PHY layer 2-20 or 2-25 may channel-code and modulate upper layer data into OFDM symbols and transmit the OFDM symbols via a wireless channel, or may demodulate OFDM symbols received via a wireless channel and channel-decode and deliver the OFDM symbols to an upper layer.

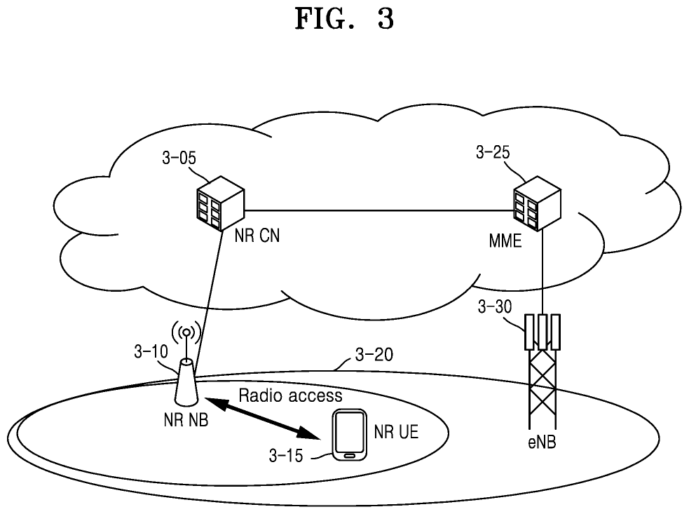

FIG. 3 illustrates a next-generation mobile communication system according to an embodiment.

Referring to FIG. 3, a radio access network of the next-generation mobile communication system (e.g., a NR or 5GS) may include a next-generation BS (i.e., an NR node B, e.g., NR gNB or NR BS) 3-10 and an NR core network (NR CN) 3-05. A NR UE (or NR terminal) 3-15 may access an external network via the NR gNB 3-10 and the NR CN 3-05.

The NR gNB 3-10 may correspond to an eNB of a legacy LTE system. The NR gNB 3-10 may be connected to the NR UE 3-15 via wireless channels and may provide superior services, compared to a legacy node B.

In the NR or 5G system, all user traffic data may be serviced via shared channels. Therefore, an entity for performing scheduling by collecting, e.g., buffer state information of UEs, available transmit power state information, and channel state information may be required, and the NR gNB 3-10 may operate as such an entity.

An NR gNB 3-10 may control a plurality of cells.

In the NR or 5G system, a bandwidth greater than the legacy maximum bandwidth of the legacy LTE system may be applied to achieve an ultrahigh data rate. Also, a beamforming technology may be additionally associated with OFDM as a radio access technology. AMC may also be used to determine a modulation scheme and a channel coding rate in accordance with a channel state of the NR UE 3-15.

The NR CN 3-05 may perform functions such as mobility support, bearer establishment, quality of service (QOS) configuration, etc. The NR CN 3-05 is an entity for performing a mobility management function and various control functions on the NR UE 3-15 and may be connected to a plurality of BSs.

Also, the NR or 5G system may cooperate with the LTE system, and the NR CN 3-05 may be connected to an MME 3-25 via a network interface. The MME 3-25 may be connected to the eNB 3-30 that is the LTE BS.

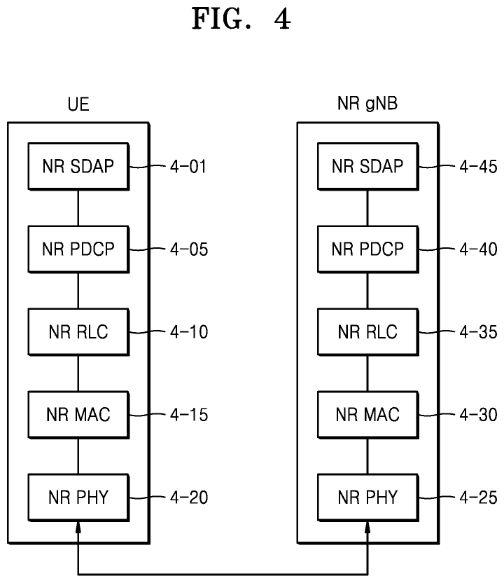

FIG. 4 illustrates a radio protocol architecture of a next-generation mobile communication system according to an embodiment.

Referring to FIG. 4, the radio protocol architecture of the next-generation mobile communication system may include NR service data adaptation protocol (SDAP) layers 4-01 and 4-45, NR PDCP layers 4-05 and 4-40, NR RLC layers 4-10 and 4-35, NR MAC layers 4-15 and 4-30, and NR PHY layers 4-20 and 4-25, respectively, for a UE and an NR gNB.

Functions of the NR SDAP layer 4-01 or 4-45 may include some of the following functions:
Transfer of user plane data
Mapping between a QoS flow and a data radio bearer (DRB) for both DL and UL
Marking QoS flow identification (ID) in both DL and UL packets
Reflective QoS flow to DRB mapping for the UL SDAP PDUs

With regard to the NR SDAP layer 4-01 or 4-45, the UE may be configured with information about whether to use a header of the NR SDAP layer 4-01 or 4-45 or to use functions of the NR SDAP layer 4-01 or 4-45 by using a radio resource control (RRC) message per PDCP layer 4-05 or 4-40, per bearer, or per logical channel. When the SDAP header is configured, a 1-bit non access stratum (NAS) reflective QoS indicator and a 1-bit access stratum (AS) reflective QoS indicator of the SDAP header may be used to indicate the UE to update or reconfigure UL and DL QoS flow and data bearer mapping information. The SDAP header may include QoS flow ID information indicating QoS. QoS information may be used as data processing priority information or scheduling information for appropriately supporting a service.

Functions of the NR PDCP layer 4-05 or 4-40 may include some of the following functions:
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in UL.

In the descriptions above, the reordering function of the NR PDCP layer 4-05 or 4-40 may indicate a function of reordering PDCP PDUs received from a lower layer, on a PDCP sequence number (SN) basis. The reordering function of the NR PDCP layer 4-05 or 4-40 may include a function of delivering the reordered data to an upper layer in order or may include a function of immediately delivering the reordered data out of order, may include a function of recording missing PDCP PDUs by reordering the received PDCP PDUs, may include a function of reporting status information of the missing PDCP PDUs to a transmitter, and a function of requesting to retransmit the missing PDCP PDUs.

Functions of the NR RLC layer 4-10 or 4-35 may include at least some of the following functions:
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment.

In the descriptions above, the in-sequence delivery function of the NR RLC layer 4-10 or 4-35 may indicate a function of delivering RLC SDUs received from a lower layer, to an upper layer in order. When a plurality of RLC SDUs segmented from one RLC SDU are received, the in-sequence delivery function of the NR RLC layer 4-10 or 4-35 may include a function of reassembling the RLC SDUs and delivering the reassembled RLC SDU.

The in-sequence delivery function of the NR RLC layer 4-10 or 4-35 may include a function of reordering received RLC PDUs on a RLC SN or PDCP SN basis, may include a function of recording missing RLC PDUs by reordering the received RLC PDUs, may include a function of reporting status information of the missing RLC PDUs to a transmitter, and may include a function of requesting to retransmit the missing RLC PDUs.

The in-sequence delivery function of the NR RLC layer 4-10 or 4-35 may include a function of delivering only RLC SDUs prior to a missing RLC SDU, to an upper layer, in order, when the missing RLC SDU exists.

The in-sequence delivery function of the NR RLC layer 4-10 or 4-35 may include a function of delivering all RLC SDUs received before a timer starts, to an upper layer, in order, when a certain timer is expired, even when a missing RLC SDU exists.

The in-sequence delivery function of the NR RLC layer 4-10 or 4-35 may include a function of delivering all RLC SDUs received up to a current time, to an upper layer, in order, when a certain timer is expired, even when a missing RLC SDU exists.

The NR RLC layer 4-10 or 4-35 may process the RLC PDUs in order of reception and may deliver the RLC PDUs to the NR PDCP layer 4-05 or 4-40, regardless of SNs (out-of-sequence delivery).

When the NR RLC layer 4-10 or 4-35 receives a segment, the NR RLC layer 4-10 or 4-35 may reassemble the segment with other segments stored in a buffer or subsequently received, into a whole RLC PDU and may deliver the RLC PDU to the NR PDCP layer 4-05 or 4-40.

The NR RLC layer 4-10 or 4-35 may not have a concatenation function, and the NR MAC layer 4-15 or 4-30 may perform the concatenation function or the concatenation function may be replaced with a multiplexing function of the NR MAC layer 4-15 or 4-30.

In the descriptions above, the out-of-sequence delivery function of the NR RLC layer 4-10 or 4-35 may refer to a function of directly delivering RLC SDUs received from a lower layer, to an upper layer, out of order. The out-of-sequence delivery function of the NR RLC layer 4-10 or 4-35 may include a function of reassembling a plurality of RLC SDUs segmented from one RLC SDU and delivering the reassembled RLC SDU when the segmented RLC SDUs are received. The out-of-sequence delivery function of the NR RLC layer 4-10 or 4-35 may include a function of recording missing RLC PDUs by storing RLC SNs or PDCP SNs of received RLC PDUs and reordering the received RLC PDUs.

The NR MAC layer 4-15 or 4-30 may be connected to a plurality of NR RLC layers configured for one UE, and functions of the NR MAC layer 4-15 or 4-30 may include some of the following functions:
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding.

The NR PHY layer 4-20 or 4-25 may channel-code and modulate upper layer data into OFDM symbols and transmit the OFDM symbols via a wireless channel, or may demodulate OFDM symbols received via a wireless channel and channel-decode and deliver the OFDM symbols to an upper layer.

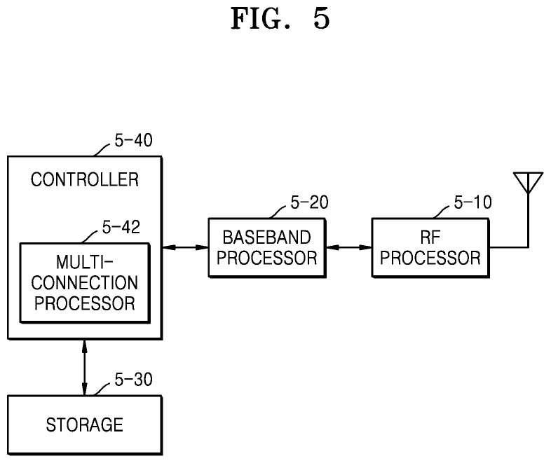

FIG. 5 illustrates a UE according to an embodiment.

Referring to FIG. 5, the UE includes a radio frequency (RF) processor 5-10, a baseband processor 5-20, a storage 5-30, and a controller 5-40.

The RF processor 5-10 may perform functions of transmitting and receiving signals via radio channels, such as band conversion and amplification of the signals. That is, the RF processor 5-10 up-converts a baseband signal provided from the baseband processor 5-20, into an RF band signal and then transmits the RF band signal via an antenna, and down-converts an RF band signal received via the antenna, into a baseband signal. The RF processor 5-10 may include a transmission filter, a reception filter, an amplifier, a mixer, an oscillator, a digital-to-analog convertor (DAC), an analog-to-digital convertor (ADC), etc.

Although only one antenna is illustrated in FIG. 5, the UE may include a plurality of antennas. Also, the RF processor 5-10 may include a plurality of RF chains.

In addition, the RF processor 5-10 may perform beamforming. For beamforming, the RF processor 5-10 may respectively adjust phases and intensities of signals to be transmitted or received via a plurality of antennas or antenna elements. Also, the RF processor 5-10 may perform a MIMO operation and may receive a plurality of layers in the MIMO operation.

The baseband processor 5-20 converts between a baseband signal and a bitstream based on physical entity specifications of a system. For example, for data transmission, the baseband processor 5-20 generates complex symbols by encoding and modulating a transmission bitstream. For data reception, the baseband processor 5-20 reconstructs a received bitstream by demodulating and decoding a baseband signal provided from the RF processor 5-10.

For example, according to an OFDM scheme, for data transmission, the baseband processor 5-20 generates complex symbols by encoding and modulating a transmit bitstream, maps the complex symbols to subcarriers, and then configures OFDM symbols by performing inverse fast Fourier transform (IFFT) and cyclic prefix (CP) insertion. For data reception, the baseband processor 5-20 segments a baseband signal provided from the RF processor 5-10, into OFDM symbol units, reconstructs signals mapped to subcarriers by performing fast Fourier transform (FFT), and then reconstructs a received bitstream by demodulating and decoding the signals.

The baseband processor 5-20 and the RF processor 5-10 transmit and receive signals as described above. Accordingly, the baseband processor 5-20 and the RF processor 5-10 may be referred to as a transmitter, a receiver, a transceiver, or a communicator.

In addition, at least one of the baseband processor 5-20 or the RF processor 5-10 may include a plurality of communication modules to support a plurality of different radio access technologies.

Also, at least one of the baseband processor 5-20 or the RF processor 5-10 may include different communication modules to process signals of different frequency bands. For example, the different radio access technologies may include a wireless local area network (LAN) (e.g.: IEEE 802.11), a cellular network (e.g.: LTE), etc. Also, the different frequency bands may include a super-high frequency (SHF) (e.g., 2.NRHz, NRhz) band and a millimeter wave (mmWave) (e.g., 60 GHZ) band.

The storage 5-30 may store programs, application programs, and data, e.g., configuration information, for operations of the UE. In particular, the storage 5-30 may store information associated with a second access node that performs wireless communication by using a second radio access technology. The storage 5-30 provides the stored data according to the request by the controller 5-40.

The controller 5-40 controls overall operations of the UE. For example, the controller 5-40 transmits and receives signals via the baseband processor 5-20 and the RF processor 5-10. Also, the controller 5-40 records and reads data on or from the storage 5-40. To this end, the controller 5-40 may include at least one processor. For example, the controller 5-40 may include a communication processor for controlling communications and an application processor (AP) for controlling an upper layer such as an application program.

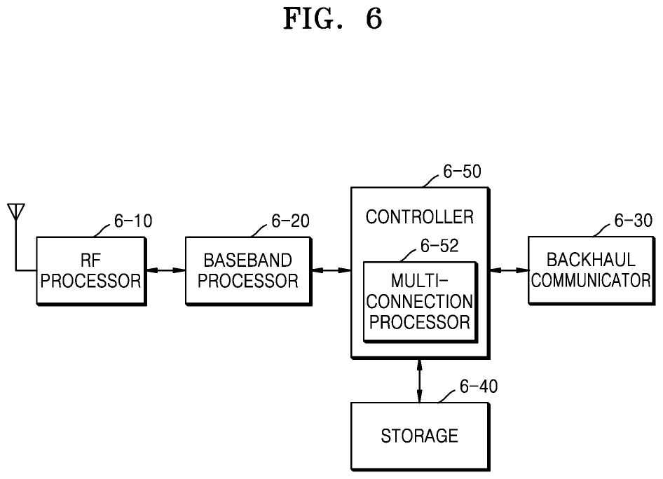

FIG. 6 illustrates an NR BS according to an embodiment.

Referring to FIG. 6, the NR BS includes an RF processor 6-10, a baseband processor 6-20, a backhaul communicator 6-30, a storage 6-40, and a controller 6-50.

The RF processor 6-10 performs functions of transmitting and receiving signals via radio channels, e.g., band conversion and amplification of the signals. That is, the RF processor 6-10 up-converts a baseband signal provided from the baseband processor 6-20, into an RF band signal and then transmits the RF band signal via an antenna, and down-converts an RF band signal received via an antenna, into a baseband signal. The RF processor 6-10 may include a transmission filter, a reception filter, an amplifier, a mixer, an oscillator, a DAC, an ADC, etc.

Although only one antenna is illustrated in FIG. 6, a first access node may include a plurality of antennas. Also, the RF processor 6-10 may include a plurality of RF chains.

In addition, the RF processor 6-10 may perform beamforming. For beamforming, the RF processor 6-10 may respectively adjust phases and intensities of signals to be transmitted or received via a plurality of antennas or antenna elements. The RF processor 6-10 may perform a DL MIMO operation by transmitting one or more layers.

The baseband processor 6-20 converts between a baseband signal and a bitstream, based on physical entity specifications of a first radio access technology. For example, for data transmission, the baseband processor 6-20 generates complex symbols by encoding and modulating a transmission bitstream. For data reception, the baseband processor 6-20 reconstructs a received bitstream by demodulating and decoding a baseband signal provided from the RF processor 6-10.

For example, according to an OFDM scheme, for data transmission, the baseband processor 6-20 generates complex symbols by encoding and modulating a transmission bitstream, maps the complex symbols to subcarriers, and then configures OFDM symbols by performing IFFT and CP insertion. For data reception, the baseband processor 6-20 segments a baseband signal provided from the RF processor 6-10, into OFDM symbol units, reconstructs signals mapped to subcarriers by performing FFT, and then reconstructs a received bitstream by demodulating and decoding the signals.

The baseband processor 6-20 and the RF processor 6-10 transmit and receive signals as described above. Accordingly, the baseband processor 6-20 and the RF processor 6-10 may be called a transmitter, a receiver, a transceiver, a communicator, or a wireless communicator.

The backhaul communicator 6-30 provides an interface for communicating with other nodes in a network. That is, the backhaul communicator 6-30 converts a bitstream, which is transmitted from the primary BS to another node, e.g., a secondary BS, a core network, etc., into a physical signal, and converts a physical signal, which is received from another node, into a bitstream.

The storage 6-40 stores programs, application programs, and data, e.g., configuration information, for operations of a primary BS. In particular, the storage 6-40 may store information about bearers allocated for a connected UE and measurement results reported from the connected UE. Also, the storage 6-40 may store criteria information used to determine whether to provide or release DC to or from the UE. The storage 6-40 provides the stored data according to the request by the controller 6-50.

The controller 6-50 controls overall operations of the BS. For example, the controller 6-50 transmits and receives signals via the baseband processor 6-20 and the RF processor 6-10, or the backhaul communicator 6-30. Also, the controller 6-50 records and reads data on or from the storage 6-40. To this end, the controller 6-50 may include at least one processor.

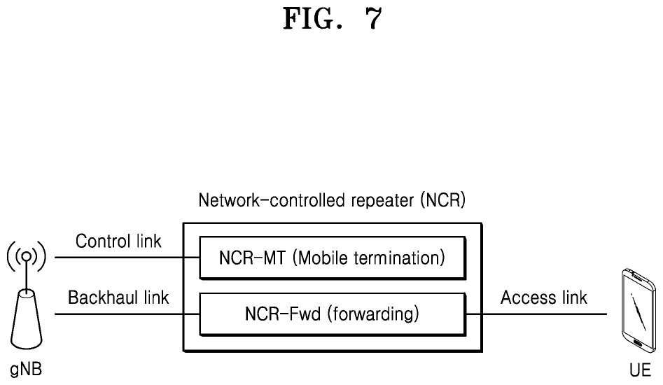

FIG. 7 illustrates an NCR according to an embodiment.

Referring to FIG. 7, the NCR may include an NCR-MT and an NCR-FWD. The NCR-MT may be configured to receive a control signal for an NCR operation from a serving gNB, and deliver control information to the NCR-FWD.

The NCR-FWD is configured to amplify an RF signal received from a gNB and transmit an amplified RF signal to the UE. Based on the control information received from the NCR-MT, the NCR-FWD may perform an additional operation. The NCR-FWD may transmit an amplified signal to the UE or receive a signal transmitted from the UE, by using a specific beam. Also, the NCR-FWD may perform or not perform reception/amplification/delivery of a signal from the gNB or reception/amplification/delivery of a signal from the UE, according to a specific time division duplex (TDD) pattern.

Hereinafter, the NCR-MT may also be referred to as the MT, and the NCR-FWD may also be referred to as the FWD.

When the NCR MT experiences BF in a control-link (C-link), the NCR FWD may perform an OFF operation.

According to an embodiment, the OFF operation may include a case in which at least one of the operations described below is not performed.

The NCR-FWD does not perform a reception operation for a signal from the gNB in a backhaul link.

The NCR-FWD does not perform amplification/transmission of a signal received in an access link.

According to an embodiment, while an operation of beams of a given access link according to side control information for the NCR-FWD is performed, a forwarding operation per beam is not performed.

When cell reselection is performed, the FWD may become OFF. However, there is currently no clear agreement as to which configuration the FWD refers to perform an ON operation, after the FWD becomes OFF.

Fast resuming of a FWD operation may be important for UEs that are served by the FWD. For example, if the FWD does not rapidly operate again, a time in which the served UEs lose a signal may increase, and thus, the UEs may have to perform handover to another cell or experience an unnecessary connection restriction due to declaration of a radio link failure. In particular, a beam-associated operation of the NCR is very short in a symbol level and thus is sensitive to a time scale, and as the NCR can rapidly perform a forwarding operation, if possible, fast resuming of a FWD operation is important.

In BF, the same beam as the C-link may be used for a backhaul link. The BF in the C-link means that a signal corresponding to a source of forwarding in the backhaul link is bad and is not reliable. In this case, it is reasonable that the FWD becomes OFF.

As detection of the BF inherits an operation of the UE, the MT may detect the BF in the C-link by itself. However, for resuming of an ON operation of the FWD, the BF has to be recovered. With respect to the recovery from the BF, a time when the MT detects the recovery may be different from a time when a network detects the recovery. Accordingly, a time of the ON operation of the FWD and resuming of the ON operation may vary according to which entity recognizes recovery from the BF.

A case in which an indicator associated with particular BF occurs by a particular number or more may be defined as BF. When the BF occurs, a MAC entity of the MT may notify BF detection to an upper layer.

When the upper layer of the MT receives the notification, the upper layer may indicate OFF to the FWD. The OFF indication may be implemented via one of the methods below.

### Method 1

When an RRC layer of the NCR MT receives a notification of BF detection from the MAC entity, the RRC layer of the MT may indicate OFF to the FWD. In this case, the MT may deliver, to the upper layer or the RRC layer, an indication indicating occurrence of BF of the NCR MT and/or an indicator indicating OFF of the FWD.

### Method 2

When an RRC layer of the MT receives a notification from the MAC entity, the MT may release or remove NCR side control information configuration information received from the gNB. In this case, according to information being released or removed, an OFF operation of the FWD may vary.

For example, when operation configuration with respect to transmission/reception beams of an access link and a backhaul link are all released or removed from the NCR side control information, the FWD may suspend both reception and transmission operations.

When configuration information associated with a beam of the access link is removed from the NCR side control information, the FWD may perform a reception operation but may suspend a transmission operation.

When configuration associated with an aperiodic beam of the access link is removed from the NCR side control information, the FWD may suspend only an operation associated with the aperiodic beam, other than an operation of a semi/persistent beam.

### Method 3

When BF is detected regardless of an operation in a layer, an NCR forwarding operation may be suspended.

Methods 1 and 2 may be combined. For example, upon reception of a BF detection notification from the MAC entity, when the RRC layer of the MT indicates OFF to the FWD, the RRC layer of the MT may specify, as detail information, configuration information to be released/removed from side control information and may deliver the configuration information to the FWD.

After the MT detects the BF, the MAC entity and a PHY entity may perform a BF recovery operation. The BF recovery operation may include a random access via a BF recovery-specific random access resource or a normal random access resource.

When the BF recovery is performed, completion of the BF recovery that the MT can recognize may be available in the following cases:
A random access procedure for the BF recovery is successfully completed; or
Reception of a physical DL control channel (PDCCH) indicating new UL grant or completion of random access response (RAR) reception or contention resolution; or
Upon reception of a PDCCH indicating UL grant for new transmission for a HARQ process to be used for transmission of a BF recovery (BFR) MAC control element (CE) for this a transmission/reception point (TRP)
Random access procedure for BF Recovery was successfully completed; or
receiving PDCCH indicating new UL grant or completion of RAR reception or contention resolution; or
Upon reception of a PDCCH indicating an UL grant for a new transmission for the HARQ process used for the transmission of the BFR MAC CE for this TRP.

In this case, the network may transmit a response (e.g., an RAR) with respect to transmission of a random access preamble that is a random access attempt of the MT. The response may include DL control information (DCI) in the PDCCH, as above.

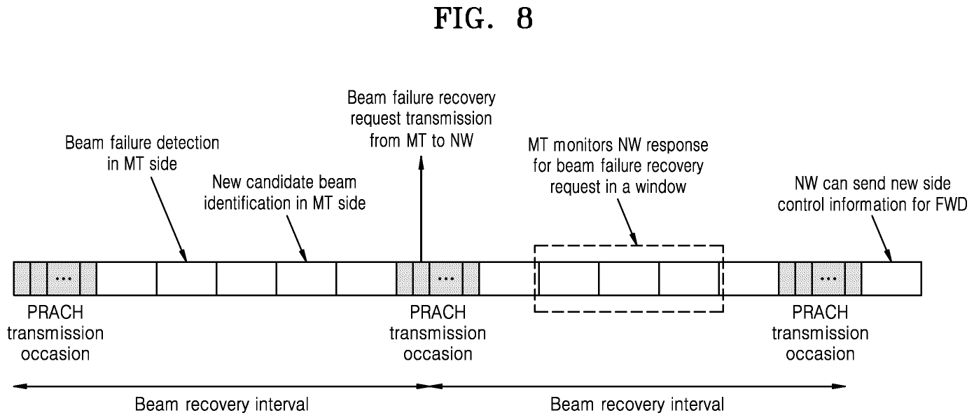

FIG. 8 illustrates a procedure for performing a BF recovery in an MT side, according to an embodiment.

Referring to FIG. 8, when an MT detects BF, the MT may find an available beam from among candidate beams, and may transmit, by using the beam, a preamble in a configured RACH transmission time. Thereafter, the MT may monitor a response delivered by a network (NW) during a preset time window. If the MT receives an RAR transmitted from the NW, according to the monitoring, it is considered that the BF recovery is completed in MT side.

However, in view of the NW, the NW may recognize completion of the BF recovery only when successful reception of the RAR is confirmed.

Accordingly, there may be a method (Method A) of resuming ON of a FWD in a BF recovery in an MT side, and a method (Method B) of receiving a resuming signal with respect to FWD ON from a network. In particular, in the latter case, after the BF recovery, the network may transmit separate side control information.

Method A: An MT automatically recognizes a BF recovery, and thus, resumes FWD ON.

In a case of the BF recovery recognized by the MT, a MAC entity of the MT may notify completion of the BF recovery of the MT to an upper layer. Here, an indication of FWD ON or FWD resume may be additionally included therein.

The upper layer may indicate FWD ON to the FWD.

In this case, the FWD may operate the FWD by using latest side control information (i.e., most recent side control information before BF). The FWD may be operated by using the following configuration information:
Using access link beam configuration:
   For periodic beam: FWD would forward (resume) the received signal over each indicated beam and its corresponding time resource (symbol position in time, and symbol duration for forwarding)
   For aperiodic beam: over the latest indicated beam (before BF) by DCI can be used for forwarding the received signal over, using the time resource configured before BF.
Using backhaul link beam configuration:
   Semi-static beam: FWD would use the UL/DL beam indicated by MAC CE before BF.
   Adaptive beam: FWD use latest indicated by a MAC CE and/or DCI for the adaptive beam before BF.
All the time resource to be used is just after the BFR indicated time.

If, a previous OFF operation of the FWD was the Method 2 (e.g., a case where specific side control information configuration information was released), the Method A cannot be used. That is, when an OFF operation of the FWD is Method 1 and Method 3, the Method A may be used in resuming of FWD ON.

Method B: A method of resuming FWD ON based on information from a network.

When the MT recognizes that a BF recovery is completed, the FWD may still maintain an OFF state, regardless of a time of the recognition. However, when the network provides separate side control information, the FWD may simultaneously resume ON.

According to types of the delivered side control information, the following operations may be performed:
New side control information for access haul link configuration via DL RRC msg
In this case, an operation is possible, in which a beam indicated as a periodic beam of an access haul is ON during an indicated time.
New side control information for backhaul link configuration via DL RRC msg
In this case, an operation is possible, in which a beam indicated as a semi-static beam of a backhaul is ON during an indicated time.
If configuration of a beam to be used on an existing C-link is already delivered via RRC, or the use of a specific beam is configured for the MT via a MAC CE/DCI, after configuration of a new C-link beam is delivered to the MT via RRC, even when a separate MAC CE and/or DCI about a semi-static beam of a backhaul link is not received, a currently-used beam on the C-link may be used as a semi-static and/or adaptive beam of an NCR backhaul link.

According to another embodiment of the disclosure, in OFF of the FWD, when the MT does not remove previous side control information configuration (Method 1 or 3), the network may indicate an ON indicator of the FWD to the UE via a DL RRC or a DL MAC CE or DCI. In this case, latest side control information may be applied as access/backhaul beam configuration so as to resume FWD ON.

When the MT receives new side control information of the NW or an indication/message about FWD ON, the MT may indicate ON or resuming of ON to the FWD via a separate signal (e.g., RRC).

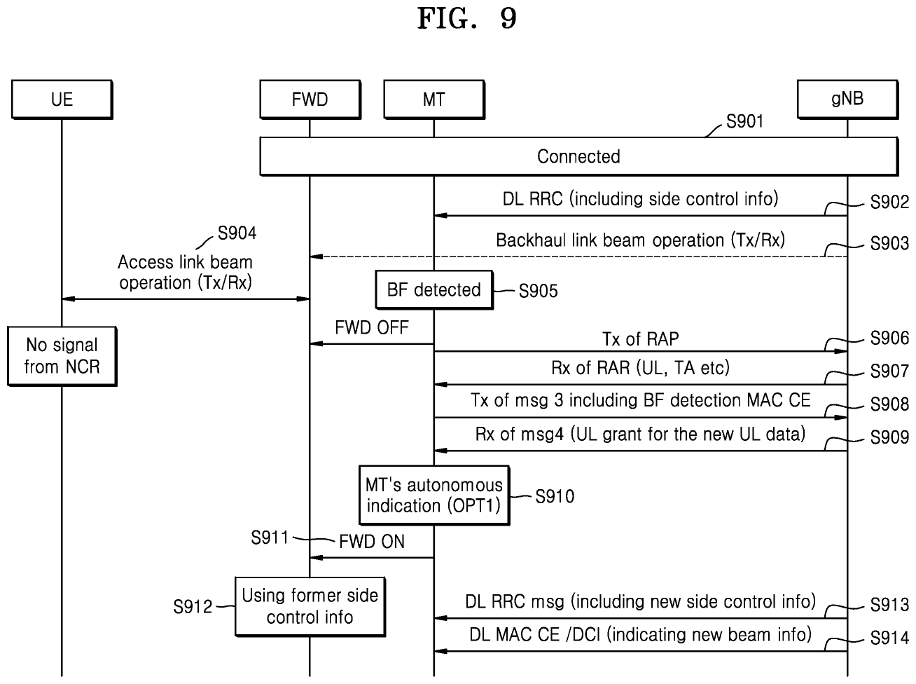

FIG. 9 is a signal flow diagram illustrating a method of resuming FWD ON, according to an embodiment. More specifically, FIG. 9 is a signal flow diagram of Method A.

Referring to FIG. 9, in step 901, an NCR is connected to a serving gNB.

In step 902, the serving gNB delivers access link beam configuration information, to the MT, by providing side control information, via a DL RRC message. Configuration of beams to be used on a C-link may be additionally delivered. In step 903, configuration information about an adaptive beam and/or a semi-static beam on a backhaul link may be informed in DCI and/or a MAC CE.

When beam information about the backhaul and the access haul are received, the NCR may perform amplifying and forwarding to the UE by performing FWD ON in step 904.

In step 905, when BF on the C-link occurs, a BF recovery operation may be performed. The MT may search for an available C-link beam, and if the available C-link beam is found, in step 906, the MT may deliver, by using the beam, an RA preamble (RAP) to the serving gNB by using a BF specific or normal random access resource. The serving gNB may receive the preamble, and in step 907, may inform the MT of a UL grant and a TA value by delivering an RAR to the MT.

In step 908, the MT may inform the gNB of BF detection via a MAC CE by using the received TA and UL grant.

The serving gNB may check the MAC CE and then recognize the BF. In step 909, the gNB may deliver, to the MT, msg 4 including UL grant for new UL data.

In step 910, the MT may recognize that the BF is recovered, and may notify an RRC layer of the MT about the BF recovery.

Upon reception of the notification, the RRC layer may indicate ON to the FWD in step 911.

Upon reception of the indication, the FWD may resume ON by using previously-had FWD side control information in step 912. That is, the FWD may receive a signal in a backhaul link, and may amplify and deliver the signal on a configured beam of an access link.

In steps 914 and 913, for the BF recovery, the gNB may additionally perform an operation of changing a beam on the C-link via a DL MAC CE and/or DCI, and may deliver side control information about the C-link and access link by using a DL RRC message.

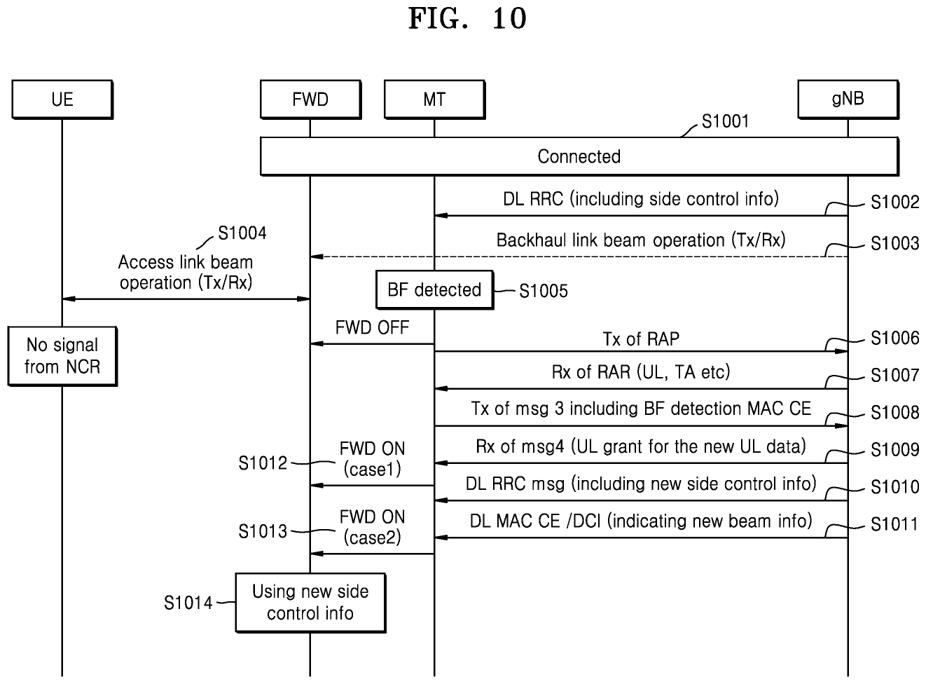

FIG. 10 is a signal flow diagram illustrating a method of resuming FWD ON based on information from a network, according to an embodiment. More specifically, FIG. 10 is a signal flow diagram of Method B.

Referring to FIG. 10, in step 1001, an NCR is connected to a serving gNB.

In step 1002, the serving gNB delivers access link beam configuration information by providing side control information via a DL RRC message. In addition, configuration of beams to be used on a C-link may also be delivered. In step 1003, configuration information about an adaptive beam and/or a semi-static beam on a backhaul link may be informed in DCI and/or a MAC CE.

When the information about the backhaul and the information about the access haul are all received, the NCR may perform amplifying and forwarding by performing FWD ON in step 1004.

In step 1005, when BF on the C-link occurs, a BF recovery operation may be performed. The MT may search for an available C-link beam, and if the available C-link beam is found, the MT may deliver, by using the beam, an RAP to the serving gNB, in step 1006, by using a BF specific or normal random access resource.

The serving gNB may receive the preamble, and in step 1007, may inform the MT of a UL grant and a TA value by delivering an RAR to the MT.

In step 1008, the MT may inform the gNB BF detection via a MAC CE by using the received TA and UL grant.

The serving gNB may check the MAC CE and then recognize the BF, and, in step 1009, may deliver msg 4 including UL grant for new UL data to the MT.

In step 1010, may deliver side control information about the C-link and access link by using a DL RRC message. In step 1011, for the BF recovery, the gNB may additionally perform an operation of changing a beam on the C-link via a DL MAC CE and/or DCI.

No matter which new DL signal is delivered, the MT may perform FWD ON, in response to the signal. For example, when side control information including beam configuration of an access link is first received via an DL RRC message, a FWD ON operation to which the beam configuration of the access link is applied may be performed.

(case1) When DL MAC CE/DCI signal is received, in step 1012, the MT may perform FWD on. Also, when DL MAC CE/DCI signal for reconfiguration of a backhaul beam is received thereafter, previously-configured access link configuration may be changelessly maintained, and configuration of the backhaul beam may be changed to perform a FWD ON operation.

(case 2) When DL MAC CE/DCI signal is received after a BF recovery, in step 1013, the MT may perform FWD on. If, on the contrary, a DL MAC CE/DCI signal for reconfiguration of a backhaul beam is first received after a BF recovery, new beam configuration of a backhaul is applied to FWD ON, and the FWD may become ON by using previous beam configuration of an access link.

After the BF recovery, when initial side control information configuration information is received, the MT may indicate ON to the FWD via RRC.

Upon reception of the indication, in step 1014, the FWD may overwrite previously-obtained FWD side control information with the newly-received side control information, thereby resuming FWD ON. That is, a signal may be received in a backhaul link, the received signal may be amplified, and the amplified signal may be delivered on a configured beam of an access link.

According to an embodiment of the disclosure, in a case of BF detection in FWD OFF, a MAC entity of the MT may indicate BF detection to an RRC layer, and the RRC layer may transmit OFF indication to the FWD.

Alternatively, in a case of BF detection, the MAC entity may directly transmit OFF indication to the FWD, or regardless of an explicit indicator from the MAC entity to the RRC layer or the FWD, the NCR may perform an OFF operation on the FWD.

According to an embodiment of the disclosure, after BF, an NCR may perform a repeating operation via optimal setting.

The methods according to the embodiments of the disclosure as described in claims or specification may be implemented as hardware, software, or a combination of hardware and software.

When implemented as software, a computer-readable storage medium storing one or more programs (e.g., software modules) may be provided. The one or more programs stored in the computer-readable storage medium are configured for execution by one or more processors in an electronic device. The one or more programs include instructions directing the electronic device to execute the methods according to the embodiments of the disclosure as described in the claims or the specification.

The programs (e.g., software modules or software) may be stored in non-volatile memory including random access memory (RAM) or flash memory, read only memory (ROM), electrically erasable programmable read only memory (EEPROM), a magnetic disc storage device, a compact disc (CD)-ROM, a digital versatile disc (DVD), another optical storage device, or a magnetic cassette. Alternatively, the programs may be stored in memory including a combination of some or all of the above-mentioned storage media. Also, a plurality of such memories may be included.

In addition, the programs may be stored in an attachable storage device accessible via any or a combination of communication networks such as Internet, an intranet, a LAN, a wide LAN (WLAN), a storage area network (SAN), etc. Such a storage device may access, via an external port, a device performing the embodiments of the disclosure. Furthermore, a separate storage device on the communication network may access the device performing the embodiments of the disclosure.

In the afore-described embodiments of the disclosure, elements included in the disclosure are expressed in a singular or plural form according to the embodiments of the disclosure. However, the singular or plural form is appropriately selected for convenience of descriptions and the disclosure is not limited thereto. As such, an element expressed in a plural form may also be configured as a single element, and an element expressed in a singular form may also be configured as plural elements.

In accordance with an aspect of the disclosure, a method performed by an NCR MT in a wireless communication system is provided. The method includes receiving side control information including a forwarding configuration, in case that a beam failure occurs, transmitting, to an NCR forwarding, a first indication to cease forwarding, initiating a beam failure recovery procedure for the NCR MT, and in case that the beam failure recovery procedure is successfully completed, transmitting, to the NCR forwarding, a second indication to resume forwarding by using the forwarding configuration.

The second indication may include an indication to use a latest forwarding configuration before the beam failure.

The method may further include detecting the beam failure in a control link.

The beam failure recovery may include a random access procedure.

The NCR MT many include a MAC entity, which transmits the first indication.

In accordance with another aspect of the disclosure, an NCR MT is provided, which includes a transceiver and at least one processor. The at least one processor is configured to receive side control information including a forwarding configuration, in case that a beam failure occurs, transmit, to an NCR forwarding, a first indication to cease forwarding, initiate a beam failure recovery procedure for the NCR MT, and in case that the beam failure recovery procedure is successfully completed, transmit, to the NCR forwarding, a second indication to resume forwarding by using the forwarding configuration.

In accordance with another aspect of the disclosure, a method performed by a NCR forwarding in a wireless communication system is provided. The method includes, in case that a beam failure occurs, receiving, from an NCR MT a first indication to cease forwarding, and in case that a beam failure recovery procedure is successfully completed, receiving, from the NCR MT, a second indication to resume forwarding by using a forwarding configuration. The forwarding configuration is received before the beam failure.

In accordance with another aspect of the disclosure, an NCR forwarding is provided, which includes a transceiver and at least one processor. The at least one processor is configured to, in case that a beam failure occurs, receive, from an NCR MT, a first indication to cease forwarding, and in case that a beam failure recovery procedure is successfully completed, receive, from the NCR MT, a second indication to resume forwarding by using a forwarding configuration. The forwarding configuration is received before the beam failure.

Although specific embodiments of the disclosure are described above in the disclosure, it will be understood that various modifications may be made without departing the scope of the disclosure. Thus, the scope of the disclosure is not limited to the embodiments described herein and should be defined by the appended claims and their equivalents.

What is claimed is:

1. A method performed by a network controlled repeater (NCR) mobile termination (MT) in a wireless communication system, the method comprising:
receiving side control information including a forwarding configuration;
in case that a beam failure occurs, transmitting, to an NCR forwarding, a first indication to cease forwarding;
initiating a beam failure recovery procedure for the NCR MT; and
in case that the beam failure recovery procedure is successfully completed, transmitting, to the NCR forwarding, a second indication to resume forwarding by using the forwarding configuration.

2. The method of claim 1, wherein the second indication includes an indication to use a latest forwarding configuration before the beam failure.

3. The method of claim 1, further comprising detecting the beam failure in a control link.

4. The method of claim 1, wherein the beam failure recovery procedure includes a random access procedure.

5. The method of claim 1, wherein the NCR MT includes a medium access control (MAC) entity, and
wherein the first indication is transmitted by the MAC entity.

6. A network controlled repeater (NCR) mobile termination (MT) in a wireless communication system, the NCR MT comprising:
a transceiver; and
at least one processor configured to:
receive side control information including a forwarding configuration,
in case that a beam failure occurs, transmit, to an NCR forwarding, a first indication to cease forwarding,
initiate a beam failure recovery procedure for the NCR MT, and
in case that the beam failure recovery procedure is successfully completed, transmit, to the NCR forwarding, a second indication to resume forwarding by using the forwarding configuration.

7. The NCR MT of claim 6, wherein the second indication includes an indication to use a latest forwarding configuration before the beam failure.

8. The NCR MT of claim 6, wherein the at least one processor is further configured to detect the beam failure in a control link.

9. The NCR MT of claim 6, wherein the beam failure recovery procedure includes a random access procedure.

10. The NCR MT of claim 6, wherein the NCR MT comprises a medium access control (MAC) entity, and
wherein the first indication is transmitted by the MAC entity.

11. A method performed by a network controlled repeater (NCR) forwarding in a wireless communication system, the method comprising:
in case that a beam failure occurs, receiving, from an NCR mobile termination (MT), a first indication to cease forwarding; and
in case that a beam failure recovery procedure is successfully completed, receiving, from the NCR MT, a second indication to resume forwarding by using a forwarding configuration,
wherein the forwarding configuration is received before the beam failure.

12. The method of claim 11, wherein the second indication includes an indication to use a latest forwarding configuration before the beam failure.

13. The method of claim 11, wherein the beam failure is detected in a control link.

14. The method of claim 11, wherein the beam failure recovery procedure includes a random access procedure.

15. The method of claim 11, wherein the first indication is received from a medium access control (MAC) entity of the NCR MT.

16. A network controlled repeater (NCR) forwarding in a wireless communication system, the NCR forwarding comprising:
a transceiver; and
at least one processor configured to:
in case that a beam failure occurs, receive, from an NCR mobile termination (MT), a first indication to cease forwarding, and
in case that a beam failure recovery procedure is successfully completed, receive, from the NCR MT, a second indication to resume forwarding by using a forwarding configuration,
wherein the forwarding configuration is received before the beam failure.

17. The method of claim 16, wherein the second indication includes an indication to use a latest forwarding configuration before the beam failure.

18. The method of claim 16, wherein the beam failure is detected in a control link.

19. The method of claim 16, wherein the beam failure recovery procedure includes a random access procedure.

20. The method of claim 16, wherein the first indication is received from a medium access control (MAC) entity of the NCR MT.
